(19) United States
(12) Patent Application Publication
(10) Pub. No.: US 2022/0215423 A1
(43) Pub. Date: Jul. 7, 2022

(54) Social Media Influencer Marketplace

(71) Applicant: VITY Patent Holdco, LLC, Loveland, CO (US)

(72) Inventor: Lynne Haaland, Burbank, CA (US)

(21) Appl. No.: 17/702,430

(22) Filed: Mar. 23, 2022

Related U.S. Application Data
(62) Division of application No. 15/363,984, filed on Nov. 29, 2016.

(51) Int. Cl. G06Q 30/02; G06Q 10/06

(52) U.S. Cl. CPC G06Q 30/0243; G06Q 50/01; G06Q 10/06393; G06Q 30/0277

(57) ABSTRACT

A social media influencer advertising platform uses a feedback mechanism to help influencers manage the effectiveness of their advertisements. The feedback mechanism may be various components of an influencer's dashboard that report conversion statistics. An influencer may be able to judge their effectiveness individually or against other influencers, where effectiveness may be on downstream actions, conversions, product sales, or other activities performed by viewers of the influencer's posts. With this feedback, the influencer may be able to tune, adjust, or change their posts to improve their conversion rate and become more effective advertisers. Through the platform, brands may pay for performance, and by giving feedback to the influencers, the influencers may be able to track their performance.

### BACKGROUND

Online social media is one of the most used ways people communicate with each other. Family and friends share information about their various happenings online, but many platforms allow for users to follow other users and consume content from anyone within the various social media platforms.

Influencers are commonly thought of as those people who have amassed large online followings. These influencers can get paid to advertise for various brands. An influencer with 100,000 followers might be asked to review a product or post a favorable advertisement, and that influencer might be paid for the action.

Brands may pay influencers for their posts. Brands may have advertising campaigns that may get the word out to their target market. An advertising campaign may be designed to “engage” with a customer. In some cases, the engagement may be to have a user view an advertisement, while other times it may be to repost an advertisement, while still other engagements may be to interact with other online content sponsored by the brand. In many cases, the ultimate engagement may be for the user to purchase a product or service provided by the brand.

### SUMMARY

A social media influencer advertising platform uses a feedback mechanism to help influencers manage the effectiveness of their advertisements. The feedback mechanism may be various components of an influencer's dashboard that report conversion statistics. An influencer may be able to judge their effectiveness individually or against other influencers, where effectiveness may be on downstream actions, conversions, product sales, or other activities performed by viewers of the influencer's posts. With this feedback, the influencer may be able to tune, adjust, or change their posts to improve their conversion rate and become more effective advertisers. Through the platform, brands may pay for performance, and by giving feedback to the influencers, the influencers may be able to track their performance.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a user interface for an influencer.

FIG. 2 is a diagram illustration of an embodiment showing a schematic or functional representation of a network with an influencer marketing system.

FIG. 3 is a diagram illustration of an embodiment showing a user interface for an influencer.

FIG. 4 is a diagram illustration of an embodiment showing a user interface for an advertiser.

FIG. 5 is a flowchart illustration of an embodiment showing a method performed by an influencer when interacting with an influencer marketing system.

FIG. 6 is a flowchart illustration of an embodiment showing a method performed by an advertiser when interacting with an influencer marketing system.

FIG. 7 is a flowchart illustration of an embodiment showing a pair of methods performed by an influencer marketing system.

FIG. 8 is a diagram illustration of an embodiment showing a user interface for an influencer with a conversion funnel.

### DETAILED DESCRIPTION

Social Media Influencer Dashboard

A social media influencer marketplace may provide a dashboard to influencers that show the influencer's performance against various metrics. The dashboard may show various engagement metrics for individual posts as well as groups of posts. The engagement metrics may include actions taken by users who have been exposed to the influencer's advertisement posts.

The dashboard may give the influencer feedback about how effective their posts are for their advertisers. In many cases, a brand may pay per conversion, meaning that the advertiser may pay for certain activities that are causally linked back to the influencer's post.

In a typical use case, a brand may pay for some level of engagement of a customer with an advertisement. The level of engagement may be determined by a brand for each campaign. In general, engagement may be for a user to re-post an advertisement, interact with specific online assets, and ultimately make a purchase.

The influencer may be paid according to the number of target customers who engage. By providing tracking codes, specialized Uniform Resource Identifiers (URIs), tracking pixels, cookies, and various tracking mechanisms, the customer's engagement may be measured. When a customer is exposed to an advertisement, various tracking mechanisms may identify the connection, then may monitor when the customer engages with additional content.

The dashboard may allow the influencer to track how well their advertisements perform. This may serve as a feedback loop to help the influencer design and promote more effective advertisements. The influencers may view various metrics to judge which advertisements performed well and which did not. This may help the influencer craft better advertisements in the future.

Some campaigns may pay for a certain number of engagements. Such campaigns may not put an upper or lower limit on the number of advertisements that an influencer may post, and the influencer may be responsible for attaining a goal of the campaign.

One example may be for a campaign to pay a certain amount for each purchase by a customer. For the influencer to get paid, the customer's engagement with the influencer's advertisement may get tracked from when the customer viewed an advertisement all the way until the customer completed a purchase. The journey from advertisement to the purchase may be a series of interactions, sometimes referred to as a purchasing funnel. The dashboard may show the number of customers who may be at each stage of the funnel.

The funnel may have various mechanisms by which the influencer may target customers in certain stages of the funnel and may send specific advertisements to those customers to encourage the customers to continue through the funnel and eventual purchase.

An example of a purchasing funnel may have a free giveaway item, then a purchase of a product. The customer's interest in the free giveaway item may be a powerful indicator that the customer may be interested in the product. Thus, targeted advertisements to those customers who accepted the free giveaway item may be very effective to move the customer to the purchase stage.

Each social media platform may have different ways to communicate between participants. In some platforms, one to one or direct communication may be enabled only when both parties may have agreed to the connection. Such direct communication may be private such that those posts are not accessible to other platform users. In other platforms, one person may be able to communicate with another person but such communications may be public.

A dashboard may have an automated posting mechanism whereby an influencer may be able to send a message to the customers at a specific portion of the funnel. In many cases, the influencer may write such posts in advance, and the automated posting mechanism may send the post as the customer enters that portion of the funnel. As with other posts that the influencer may provide, performance metrics may be collected and displayed for each connection that the influencer may have with customers.

A dashboard may have comparison metrics between influencers. For example, a campaign may employ several influencers. Within an influencer's dashboard, the influencer may be able to view how well they are performing against other influencers within that campaign, as well as overall. Influencers may be ranked based on their conversion rate or other performance metric.

Such rankings may allow an influencer to read other influencer's posts and, in some cases, view the performance of each of those posts. Such a system may allow an influencer to uncover what other influencers are doing and how well those techniques may be working for the other influencers.

The influencer ranking, as well as other components of the dashboard, may help motivate influencers to improve their performance. Not only are the influencers receiving feedback about their performance, the influencers may be incented to perform better by direct comparisons to other influencers.

The influencers become ranked by performance, not just by the number of followers they have. With the proliferation of bots, automated accounts, spam accounts, or other accounts that may have no potential customer behind the account, the number of followers may not be a meaningful indicator for a brand. A brand wants performance, which may be actual engagements and an eventual purchase. By changing the metrics for an influencer from merely number of followers to actual, measured, and verified performance, the brand may have a more effective spend of their advertisement money. Further, influencers with a track record of conversion performance may be much more highly compensated than influencers without such performance.

Within this specification and claims, the following terms are used as follows:

The definitions used here are exemplary definitions for the terms and are not meant to be limiting to the precise definitions given. In the field of online communications and social media, many different terms are used for similar functions, and the use of various terms throughout this specification and claims is not intended to limit the concepts to those social media platforms that use the same terminology. The intent is to apply the terms to any communications technology that may employ similar concepts.

The terms “follow,” “friend,” or “connection” is used to refer to an express link or relationship between two users of a social media platform. In some social media platforms, certain types of communication may be enabled between users with such a link. In a typical express relationship, at least one of the parties may assent to the relationship. In some social media platforms, both parties in the relationship may assent to form a relationship

The term “social media platform” is used to refer to any mechanism by which groups of users may share information electronically. The sharing may be a one-to-one communication, one-to-many, or many-to-many. Many social media platforms may permit users to generate public content that may be available to all other platform users, as well as private content that may be restricted to groups of people. Some social media platforms may provide public access to content to people outside of the platform, while other social media platforms may provide public access to content to people who are members of the platform.

The term “post” is used to denote any content that may be shared on a social media platform. A post or posting is used as a generic term for content that may be shared. The post may contain text, images, video, audio, or any other media. In some cases, a post may be a combination of media. An advertisement may be a type of post shared at the behest of an advertiser.

The terms “repost” or “forwarding” is used to refer to an action taken by a recipient of a post. The recipient may cause a post to be shared amongst the recipient's connections within the social media platform.

The term “reply,” when used in context of a post, is used to refer to a second post made in response to a first post.

The term “conversion” is used to refer to a desired after-impression activity that an advertiser seeks to achieve. In some campaigns, a conversion may be receiving a user's email address, phone number, or some other identifying information that can be used to contact the user later. In other campaigns, a conversion may be a sale or other transaction. In still other campaigns, a conversion may be a visit to a webpage or other activity. In some campaigns, a conversion may occur over multiple steps.

The terms “advertiser” and “brand” are used to refer to a person or an organization that may desire to have specific content shared within a social media platform. In many cases, an advertiser may pay for posts to be generated and shared by members of a social media platform, although in some cases, advertisers may not pay.

The term “like” may be used as a verb or noun to refer to a response by a recipient of a post. The term “sentiment affirmation” is used as a synonym of “like.” The response of a “like” may show a recipient's sentiment about the post. Some social media platform may permit several different sentiment indicators to be generated in response to a post.

The term “non-transitory computer readable media” may refer to any form of computer readable media where the media may be in some fixed, tangible form. The term “non-transitory computer readable media” specifically excludes signals that may be used to propagate computer readable information.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory. When the subject matter is embodied in “non-transitory” media, the media may be any storage media that expressly does not include live signals.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

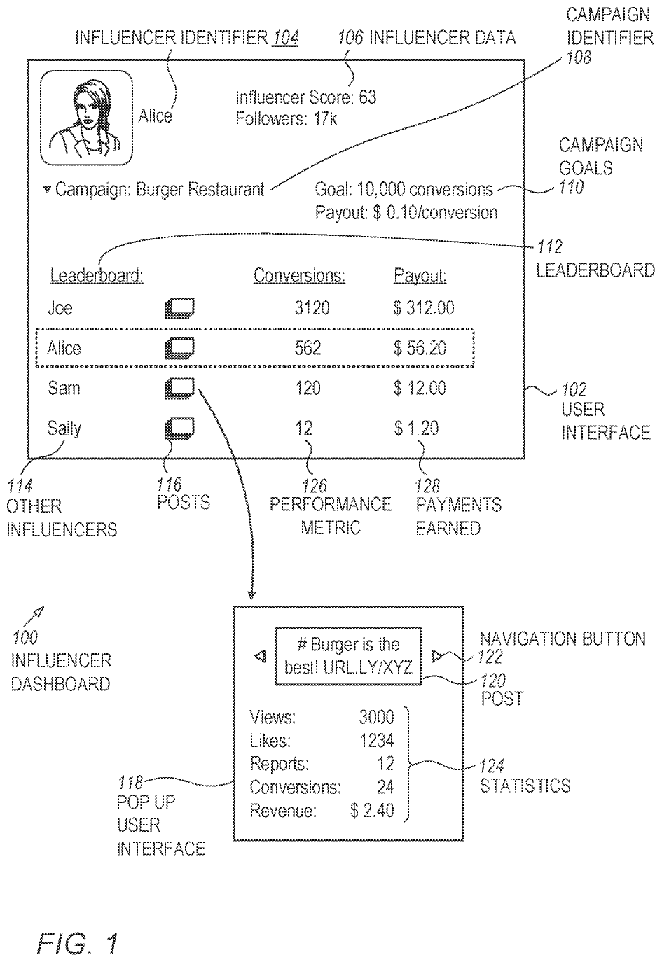

FIG. 1 is a diagram illustration of an embodiment 100 showing an influencer dashboard. The influencer dashboard may be a user interface 102 that a social media influencer may view to access their performance metrics on one or more campaigns.

A social media influencer may be a social media user who may post advertisements for an advertiser or brand. The influencer may be paid for posting the advertisements, or have some other compensation. In many cases, influencer advertisements may be particularly effective because of a bond of trust between an influencer and the audience. The trust may come from the fact that the influencer is a sports or entertainment figure, or the influencer may have built trust with their audience by providing content that the audience enjoys. In some cases, influencers may be those people who have a personal or other connection with their audience.

In a typical use scenario, social media influencers are typically people on social media with a large following. Advertisers may hire the influencers to post on the advertiser's behalf as part of an advertising campaign. A campaign may have several influencers as part of a campaign, and in many cases, an advertising campaign may operate over a period of time, such as a day, a week, a month, or longer.

Ad advertising campaign may be set up with a goal. The goal may be any type of measurable metric, such as a number of impressions, number of reposts or similar engagements, as well as number of conversions. A conversion may be any after-impression action that an advertiser may wish to achieve.

Campaigns may be set up with various ways of paying the influencers. In some campaigns, influencers may be paid per action. Such a campaign may pay influencers per post, for example. Other campaigns may pay per conversion. A conversion may be simple, such as a basic interaction such as a like, repost, reply, or other interaction. Other conversions may be more complex, such as receiving an email or physical address, or even completing a sale.

Typically, advertisers may have marketing goals for their campaigns. Some campaigns may be intended for exposure, where the goal may be just to obtain impressions. Other campaigns may be to sell a specific product, where the goal may be sales of the product.

An advertiser may provide a Uniform Resource Identifier (URI), which may be an online link to a landing page or other resource. The URI may have a tracking mechanism that may log each visit by a person, and may be able to trace the person's online activity from that point forward. For example, a post may include a URI to a website, which may use a tracking pixel or other technology to identify a user. When the user completes a transaction, a sale, or other conversion activity, a tracking system may register that user as a completed conversion and credit the influencer who provided the URI.

One version of a campaign may be to set a goal for a certain number of conversions and to pay per conversion. Several influencers may be employed to accomplish the goal, and each influencer may be paid for each conversion. Such a campaign may be illustrated in embodiment 100.

The user interface 100 may be an influencer dashboard, which may be accessed by an influencer for their interaction with an influencer marketing system. In a typical use scenario, an influencer may sign up with the influencer marketing platform and put in various credentials, including a mechanism for getting paid.

When an advertiser launches a campaign, the influencer may join a campaign in several different manners. In some cases, an advertiser may select each influencer and invite them to join the campaign. In other cases, an advertiser may post a campaign and influencers may request to join.

The user interface 102 may show an influencer's identifier 104 and other influencer data 106. In this case, our influencer is Alice, and she has an influencer score of 63 and 17,000 followers. The influencer score and other metrics may be generalized scores and metrics that may be used by influencers and advertisers to compare influencers to each other.

A campaign identifier 108 may be shown, along with campaign goals 110. In this case, the campaign identifier is “Burger Restaurant” and the campaign goals are 1000 conversions with a payout of $0.10 per conversion.

A leaderboard 112 may be presented that may show all of the other influencers 114 ranked according to performance. The rankings may be made based on a performance metric 126, and in some cases, the payments earned 128 may also be shown.

The ranking may show each influencer how they are performing against other influencers. Such a comparison may be one element of a gamification system that may incent influencers to compete against each other within the campaign.

In the example, campaign, the advertiser has committed to pay $0.10 for each conversion, up to 1000 conversions. The influencers may all try to get as many conversions as possible before the 1000 conversion has been met. Influencers may be able to post more often, craft their posts in different ways, or do other things to increase their conversions.

One benefit of exposing this information to the influencers is to make them aware of their performance against the advertiser's goals. When an influencer may be paid only by the post, the influencer may have little or no insight into how effective their posts may be, as well as how much benefit or cost they have for the advertiser.

The posts 116 may show advertisement posts that may have been posted by the various influencers in this campaign. By clicking on the posts icon, a pop up user interface 118 may be displayed, showing the post 120 as well as some navigation buttons 122 to cycle through the various posts. The statistics 124 for each post may be shown below the post.

An influencer may be able to view the posts from other influencers in the campaign and view how well the other influencer's posts may be performing. This feature may help an influencer determine what techniques may be working for other influencers and may help the influencer improve their posts.

The gamification elements of the example campaign may show the influencer that she is outperforming Sam and Sally, but that Joe is outperforming her. Alice may browse the various posts from the other influencers and may try different techniques to increase her performance.

By exposing the performance metrics to the influencer, as well as showing other influencer's performance metrics, an influencer may be focused on the same goals as the advertiser. In the example campaign, the advertiser may pay for results, not just pay for the influencers to take actions. The influencer may have the performance data such that she can focus on results as well.

Such systems may encourage influencers to be aware of and even tout their performance on various advertising campaigns. Those influencers who deliver results for advertisers may be asked to participate in more campaigns and may make more money because they deliver results.

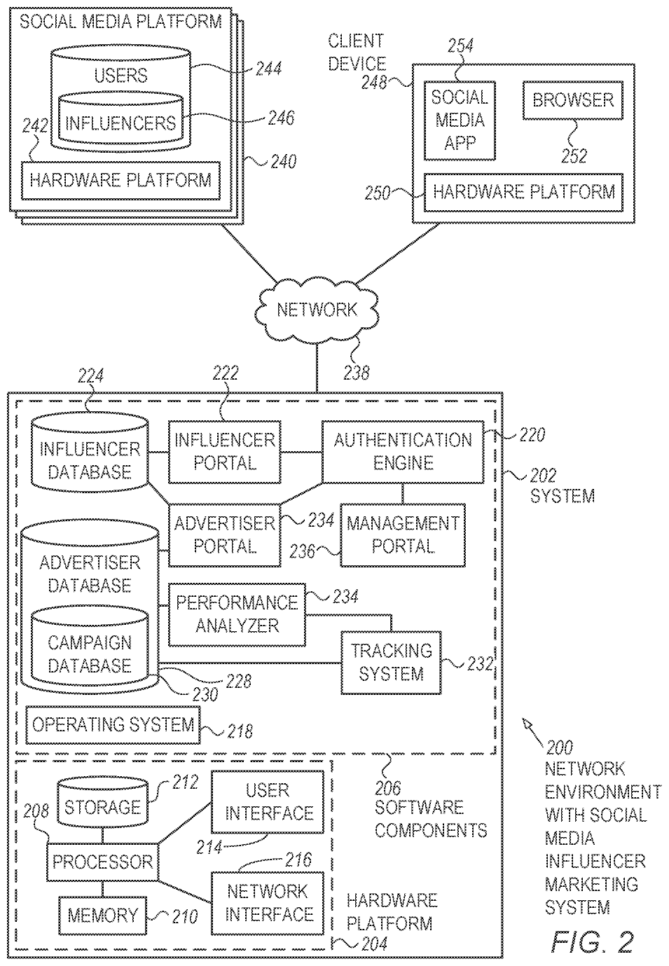

FIG. 2 is a diagram of an embodiment 200 showing components that may manage influencer marketing campaigns. The components are illustrated as being connected across a network 240.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

The software components 206 may represent an influencer marketing platform. An authentication engine 220 may establish user accounts and permit access to various functions based on a user's role. In the example of embodiment 200, different functions may be available to influencers, advertisers, and platform management.

After authentication, an influencer may interact with an influencer portal 222. An influencer database 224 may contain influencer's account information, as well as their performance metrics.

After authentication, an advertiser may interact with an advertiser portal 226. An advertiser database 228 may include account information for advertisers, as well as a campaign database 230, which may contain information about various campaigns.

A tracking system 232 may monitor activities that may occur with advertisements and other posts. The tracking system 232 may use various technologies to identify connections between a user's impression of an advertisement and subsequent activities that the user may take. The technologies may include tracking pixels, cookies, and other identifiers that may be used to identify the user's activities. Some tracking technologies may be active, such that the tracking technology may send a communication to a centralized service that may register an activity. Other tracking technologies may be passive, such that the tracking may occur when a user with a specific identifier visits a website that may have a connection to a tracking service. In some cases, a tracking system 232 may be a separate, standalone service that may operate on a separate hardware platform.

A performance analyzer 234 may track various performance metrics about campaigns and influencers, and may populate the various databases with campaign histories, performance summaries, and other data. The performance analyzer 234 may monitor campaign performance as recorded by the tracking system 232. The performance analyzer 234 may also determine performance statistics for individual posts.

A management portal 236 may be a user interface through which an administrator may access the social media influencer system. The administrator may be able to perform various maintenance and configuration functions for the system 202, such as setting up and configuring influencers, advertisers, campaigns, and other functions of the system.

The system 202 may be connected to various other systems using a network 238.

A social media platform 240 may operate on a hardware platform 242. A typical hardware platform for a social media platform may be several datacenters, each with many individual computers and processors. The social media platform 240 may have a database of users 244. Within the set of users 244 may be a set of influencers 246. The set of influencers 246 may be represented as a subset because influencers may be members or users of the social media platform that have signed up to become influencers on a social media influencer marketing system. In many cases, the social media platform may not have any special status within the platform to identify influencers separate from generic users.

The social media platform 240 is illustrated without the various communication functions that each social media platform may have. Such functions may allow users to post information that may be shared with other users, as well as various one-to-one, one-to-many, and other types of communications that may be supported. Many social media platforms may be functionality to handle video, images, audio, text, and other media, such as allowing editing and various manipulation of the media. The functions may also include specialized features that may permit different types of communications, alerts, likes, reposts, follows, and other functions. Each social media platform may have different features.

A client device 248 may represent a device that may be used to access a social media platform 240 as well as the influencer portal 222, advertiser portal 226, and management portal 236 of the system 202. The client device 248 may have a hardware platform 250 on which a browser 252 or social media app 254 may execute. Other systems may have other interfaces through which a social media platform 240 and a social media influencer system 202 may be accessed, such as application programming interfaces (API), command line interfaces, and others.

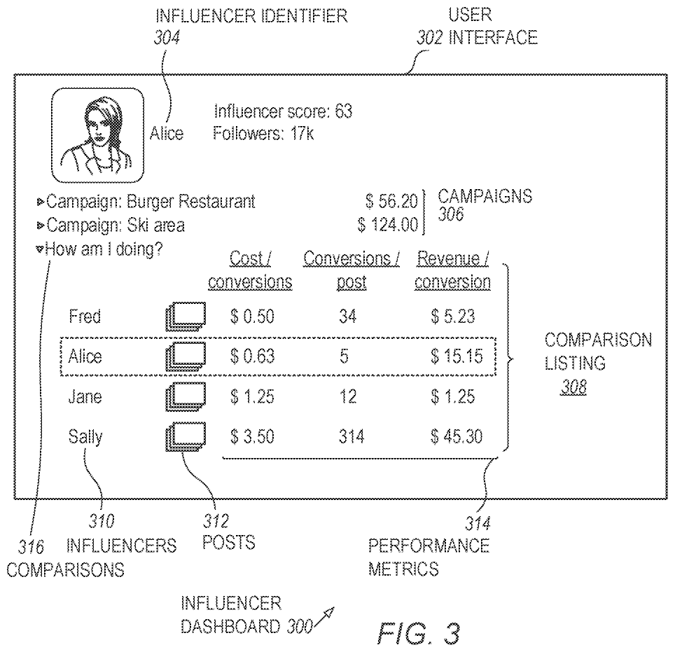

FIG. 3 is a diagram illustration of an example embodiment 300 showing an influencer dashboard. The influencer dashboard may be displayed in a user interface 302.

The influencer dashboard of embodiment 300 may be similar to that of embodiment 100, but with campaigns collapsed and a feedback section exposed. The influencer identifier 304 may be displayed, along with campaigns 306, which are illustrated as collapsed.

A list of comparisons 316 is illustrated as expanded to show various influencers 310 with their posts 312 and various performance metrics 314.

The list of comparisons 316 may give an influencer meaningful feedback on their performance in comparisons to others. Influencers can be competitive, often competing for the greatest number of followers and other metrics that may be displayed by a social media platform. By showing performance metrics that advertisers value, an influencer may concentrate on a different set of performance aspects. Specifically, the performance aspects that can help them generate income.

In the example of embodiment 300, the performance metrics 314 may include a cost per conversions, conversions per post, and revenue per conversions. Many other metrics may be shown to the influencers. In a typical embodiment, the performance metrics shown to influencers through the influencer dashboard may be the same metrics that advertisers may specify in their campaigns.

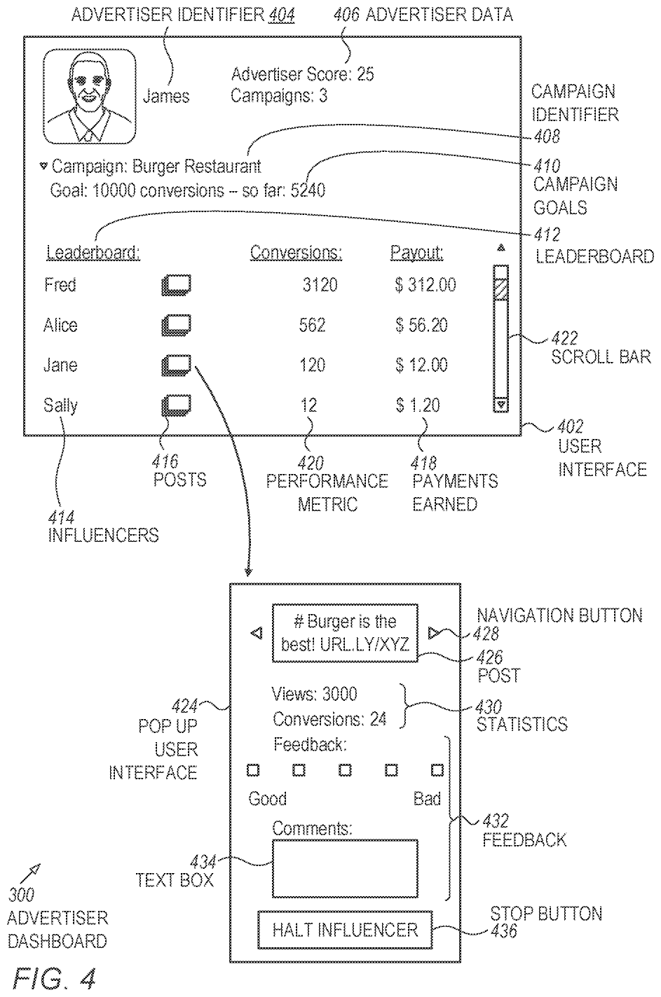

FIG. 4 is a diagram illustration of an example embodiment 400 showing an advertiser dashboard. The advertiser dashboard may be displayed in a user interface 402.

The advertiser dashboard may be a user interface viewed for a campaign that may be running or may have finished. Such a dashboard may be used to monitor the success of a campaign, as well as to provide feedback to influencers for their posts.

An advertiser identifier 404 may be shown, as well as an advertiser score 406. A campaign identifier 408 and campaign goals 410 may also be shown. In some systems, an advertiser may be able to modify various campaign goals, although such functionality may not be illustrated in embodiment 400.

A leaderboard 412 may show the influencers 414 that may be in the campaign, along with the posts 416 for each influencer. Each influencer may have their payments earned 418 as well as performance metrics 420.

A pop up user interface 424 may be launched when one of the posts icons may be clicked. The pop up user interface 424 may show a post 426, and may have various navigation buttons 428 to step through each of the various posts.

For each post, a set of statistics 430 may be illustrated, as well as a feedback mechanisms 432. The feedback mechanisms 432 may include items such as a rating meter, comments using a text box 434, and other feedback mechanisms.

The feedback mechanisms 432 may be a direct way for an advertiser to interact with an influencer. Feedback may be transmitted to the influencer through various mechanisms, and the feedback may be used to calculate an influencer score or other metrics.

The advertiser may be able to engage a stop button 436, which may allow an advertiser to immediately stop the influencer from participating in the campaign. Such a button may be activated when an influencer may post something inappropriate or otherwise violate the terms of a campaign. The stop button 436 may suspend the influencer's activities and may cause a dispute resolution process to occur.

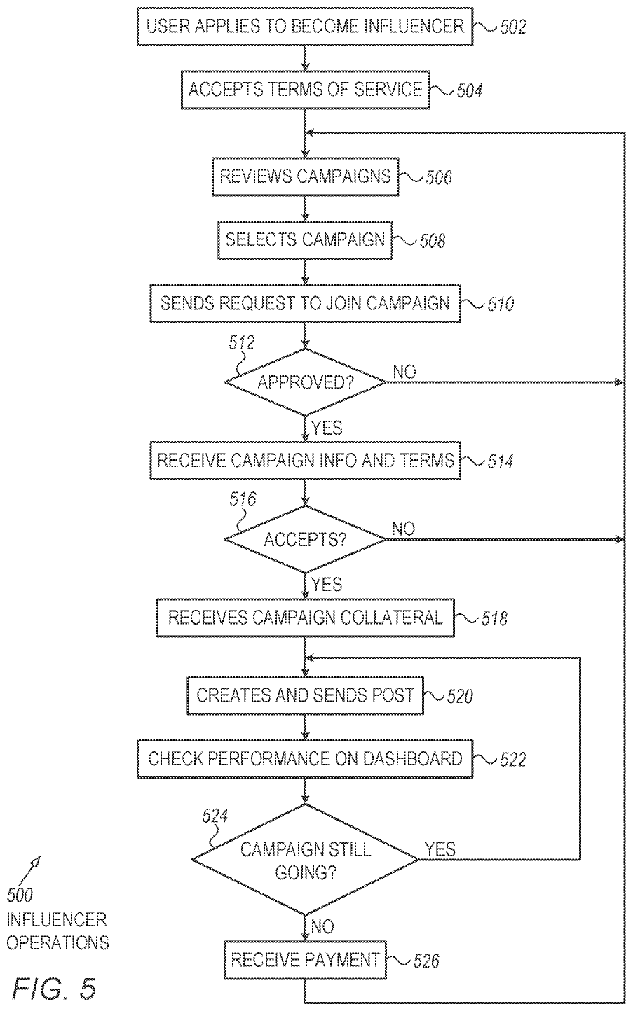

FIG. 5 is a flowchart illustration of an embodiment 500 showing a method performed by an influencer when interacting with an influencer marketing system.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The method of embodiment 500 may be performed by an influencer through a user interface. The operations of an influencer marketing system may be the corresponding operations that a device may perform in response to the influencer's actions.

A user may apply to become an influencer in block 502. The application process may be different for each influencer marketing system, but many systems may create a user identifier and password or other authentication credentials. Many systems may gather demographic information about the influencer, including the topics that the influencer may prefer, the influencer's age, their location, and many other factors. Such information may be used to generate influencer profiles, which may be used by advertisers for selecting influencers to become part of a campaign.

The influencer may accept the terms of service in block 504. In many cases, the sign in process may also include providing payment mechanisms and other administrative functions.

An influencer may review campaigns in block 506 and may select a campaign that they may wish to help. When they select a campaign in block 508, they may send a request to join a campaign in block 510. If the request is denied in block 512, the influencer may return to block 506 to try another campaign. In many cases, a system may allow an influencer to be part of many campaigns at the same time.

When the influencer is approved in block 512, they may receive detailed campaign information and terms in block 514. If they do not accept the terms in block 516, they may return to block 506 to try another campaign.

When the influencer accepts the terms of service in block 516, they may receive campaign collateral in block 518 and may begin creating and sending posts in block 520.

During the campaign, the influencer may access their dashboard in block 522. The dashboard may help them determine how well they are doing towards the campaign goals, as well as get feedback on which posts are performing well. The dashboard may also show other influencers in the campaign, which may incent the influencer to work hard at meeting the campaign goals.

While the campaign is still going on in block 524, the influencer may return to block 520 to continue posting.

When the campaign ends in block 524, the influencer may receive payment in block 526, then the cycle may repeat.

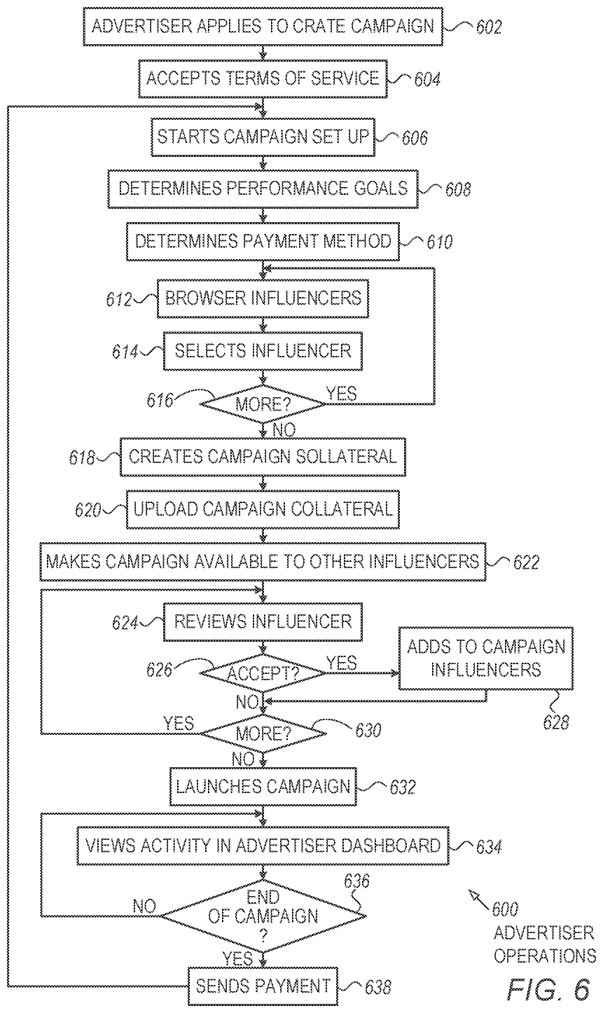

FIG. 6 is a flowchart illustration of an embodiment 600 showing a method performed by an advertiser when interacting with an influencer marketing system.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The method of embodiment 600 may be performed by an advertiser through a user interface. The operations of an influencer marketing system may be the corresponding operations that a device may perform in response to the advertiser's actions.

An advertiser may apply to create a campaign in block 602. The application process may involve various administrative functions, such as setting up account authentication, payment mechanisms, as well as describe the type of campaigns or influencers they desire. When the advertiser accepts the terms of service in block 604, they may proceed to set up a campaign in block 606.

Each system may have different mechanisms and user interfaces to help an advertiser set up a campaign. In general, campaigns may include a description, as well as various performance goals and metrics that the advertiser may wish to achieve in block 608. In addition, the advertiser may select a method of calculating payments to the influencers and other parameters about the campaign in block 610.

An advertiser may use different ways of recruiting influencers for a campaign. In one method, the advertiser may browse influencers in block 612 and select influencers in block 614. The advertiser may cycle through block 616 to block 612 to select several influencers. In many cases, the influencers may be offered an opportunity to participate, which the influencers may accept, decline, or counter offer.

The advertiser may create campaign collateral in block 618 and may upload the collateral in block 620.

Another way the advertiser may recruit influencers may be to make a campaign available to influencers in block 622. Influencers may indicate their interest, and the advertiser may review the influencer in block 624. If the advertiser accepts the influencer in block 626, the influencer may be added to the campaign in block 622. If more influencers have indicated interest in block 630, the process may cycle back to block 624.

When the influencers are accepted and ready to go, the campaign may be launched in block 632. As the campaign progresses, the advertiser may view their activity on an advertiser dashboard in block 634. Until the campaign ends in block 636, the advertiser may use the dashboard to monitor progress, give feedback to influencers, and add or remove influencers during the campaign.

Once the campaign finishes in block 636, the payments may be settled in block 638.

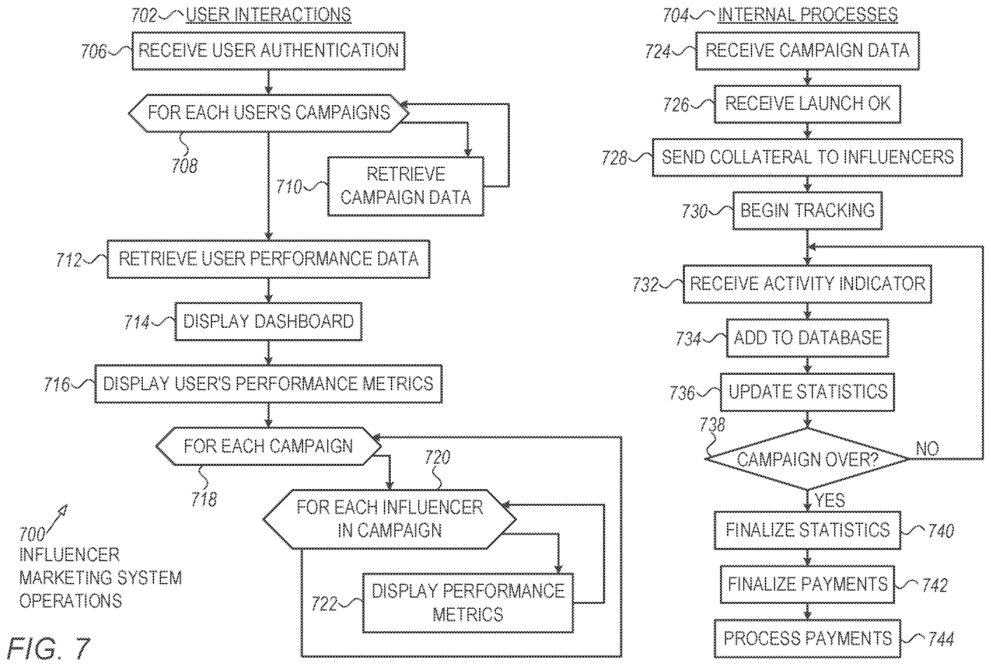

FIG. 7 is a flowchart illustration of an embodiment 700 showing methods performed by an influencer marketing system. An example of user interactions 702 may be shown in the left hand column, while an example of internal processes 704 may be shown in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The user interactions 702 may illustrate example operations that an influencer marketing system may perform in response to input from an influencer. The process illustrates how data may be gathered and displayed as an influencer dashboard.

The internal processes 704 may illustrate example operations that an influencer marketing system may perform to manage a campaign and to collect performance data about the campaign.

The user interactions 702 may begin with a user providing authentication in block 706. For each of the user's campaigns in block 708, campaign data may be retrieved in block 710. The user's performance data may be retrieved in block 712.

A user dashboard may be displayed in block 714 and may be populated with the influencer's performance metrics in block 716. For each campaign in block 718, and for each influencer in each campaign in block 720, the performance metrics for those influencers may be retrieved and displayed in block 722.

The internal processes 704 may begin with receiving campaign data in block 724 and a launch OK in block 726. This launches the campaign, beginning with sending collateral to the influencers in block 728.

Tracking may begin in block 730. As activity indicators may be received in block 732, the indicators may be added to a tracking database in block 734. Any statistics that may be derived from such data may be updated in block 736.

If the campaign is not over in block 738, the process may loop back to block 732. When the campaign has finished in block 738, the statistics may be finalized in block 740, as well as the payments in block 742. The payments may be processed in block 744.

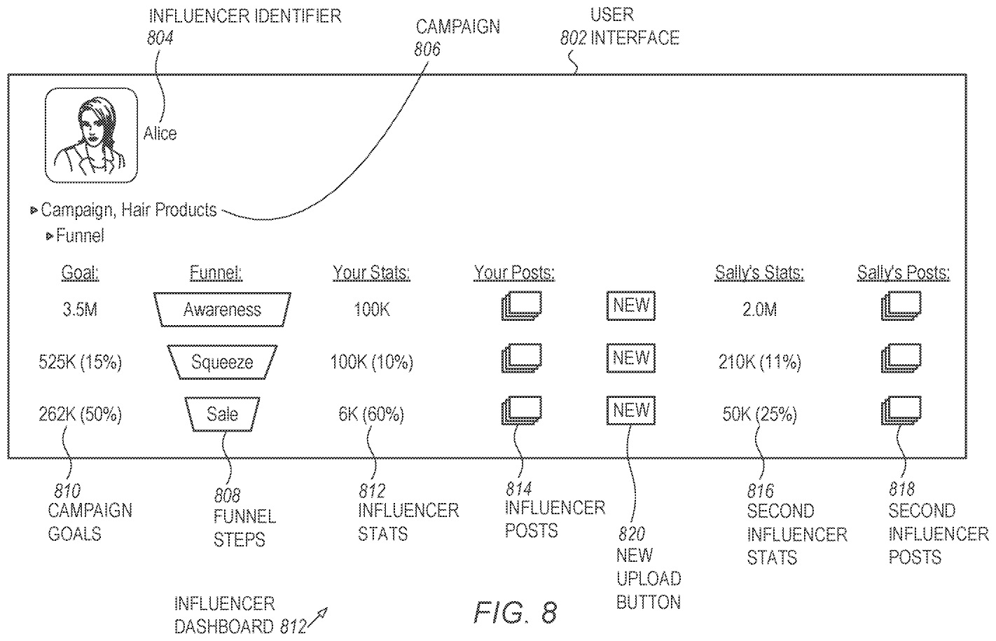

FIG. 8 is a diagram illustration of an example embodiment 800 showing a user interface 802 that shows steps in a conversion funnel.

Many marketing campaigns may have multiple steps in a conversion funnel. A typical conversion funnel may include building awareness of a brand, making an initial transaction with a customer, and eventually converting the customer with a sale. Such a conversion funnel may be used to interact with a customer multiple times, and building trust and confidence with each interaction. The culmination may be a sale of a product or service.

Conversion funnels are often used in online marketing to describe a path of interactions between the brand and a customer. Some conversion funnels may be sophisticated paths that segregate certain types of customers into sequences of offers that may appeal to that type of customer. For example, a conversion funnel may split when a customer identifies their location or other characteristic, and each customer may be presented with offers that are specific to their identities. In the example, a person in a first location may be shown offers that relate to that location, while a second person in a second location may be shown offers that relate to the second location.

A simple conversion funnel may be illustrated in embodiment 800, where the funnel may have three basic steps: awareness, a squeeze offer, and a sale. Such an illustration is merely to show a simplified conversion funnel for illustration purposes, and other embodiments may have more sophisticated and complex funnels that may include fewer or additional steps, conditions, branching, and other components.

In the example of a conversion funnel, an influencer may produce several different posts or other collateral that may be shown to customers at different stages of the funnel. The influencer may create the collateral ahead of time and an automated system may send the collateral at each step of the funnel. In such a system, the influencer may be responsible for creating and maintaining posts and other collateral for each step of the funnel. As such, the influencer may be presented with each step of the funnel and may be permitted to upload content for each step.

In the example of embodiment 800, an influencer may be able to evaluate their performance for each step of a campaign funnel, as well as to compare their performance to other influencers in the same campaign. The feedback given to the influencer may allow the influencer to improve or change their content, as well as to learn from other influencers.

Embodiment 800 may represent a user interface where an influencer may create content that may be posted in a marketing funnel, in comparison to embodiments 100 or 300 where an influencer may provide a single piece of content. In a marketing funnel, the influencer may design content that may be used at multiple steps of an interaction. In such systems, the influencer may have a larger creative input and a larger set of content deliverables to a campaign.

Embodiment 800 may represent a marketing campaign where an influencer may be paid for various steps of a campaign. For example, an influencer may be paid a small amount for each impression, but a larger amount for successful conversion of a squeeze page and an even larger amount for a successful sale. Such financial incentives may encourage the influencer to create meaningful and effective content that may be directly tied to success metrics or goals defined by a brand.

Embodiment 800 may present a campaign's goals for various steps of a marketing funnel, as well as the influencer's statistics and those of other influencers in the same campaign. Such information may be designed to give the influencer meaningful and actionable feedback to let them know how well they are doing against the campaign goals, but also as a comparison with other influencers. By referencing other influencer's posts and statistics, an influencer may be able to get examples of what may be working or not working on the campaign. The influencer may be able to tune or improve their content to maximize the campaign goals and thereby maximize the value that they add.

A user interface 800 may have an influencer identifier 804 and various campaign information 806. In the example of embodiment 800, the campaign may be “Hair Products” and the user interface 800 may be open to display the funnel.

The funnel steps 808 may be listed as “awareness,” “squeeze,” and “sale.” Awareness in this example may be the impressions that an influencer's post may have had in social media or other venue. The squeeze step may be a landing page where a customer may be pointed from an impression, and the conversion may be some sort of offer. Typically, a squeeze page may make a small offer in exchange for a user's email address or some other interaction. The sale may be a purchase that may be the objective of the marketing campaign.

An influencer may create and post content that may fulfil the awareness step. For the squeeze step, the influencer may be responsible for creating some or all of the content for a squeeze page or other landing page. In some cases, the brand may provide the entire content for the landing page. In either event, the statistics may show the effectiveness of the squeeze page through a conversion percentage or raw numbers. Similarly, for the sales page, some or all of the content may be provided by the influencer or may be provided by the brand.

The campaign goals 810 may reflect raw number and performance goals for the campaign. In the example, a campaign goal may be 3.5 million impressions, 525,000 conversions of the squeeze page, and 262,000 purchases.

The influencer statistics 812 may show how well the influencer's posts have been performing in the campaign. In this example, the influencer may have 100,000 impressions, 10,000 conversions on the squeeze page, and 6000 sales. The influencer's performance on the squeeze page may be trailing the desired conversion percentage of the campaign. The campaign conversion goal at the squeeze step may be 15%, but the influencer may be underperforming at 10%.

The influencer's post 814 may be shown as icons. In some cases, the influencer may be able to click on the posts and browse the posts as well as statistics for each one. A new posts button 820 may expose an interface by which an influencer may upload new content to be used as posts.

A set of statistics for a second influencer 816 as well as posts 818 for the second influencer may also be shown. When a campaign may have multiple influencers, the statistics and posts may be from other influencers in the same campaign. When a campaign may not have other influencers, the statistics and posts may be displayed from similar campaigns. The statistics and posts from other influencers may be useful to help guide an influencer in generating content that may be effective marketing tools.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A method performed on at least one computer processor, said method comprising:
receiving a desired demographic profile for an advertising campaign;
identifying a plurality of influencer groups, each of said influencer groups comprising a plurality of influencers;
for each of said plurality of influencer groups, determining a demographic coverage profile;
displaying a plurality of graphical representations, each of said plurality of graphic representations corresponding to one of said influencer groups; and
receiving a selection of a first influencer group.

2. The method of claim 2 further comprising:
displaying at least one demographic statistic for said first influencer group.

3. The method of claim 2, said demographic statistic being an aggregated demographic statistic.

4. The method of claim 3, said aggregated demographic statistic being generated by:
for each of said plurality of influencers, receiving a demographic profile;
aggregating said demographic profile from each of said plurality of influencers to generate said aggregated demographic statistic.

5. The method of claim 3, said aggregated demographic statistic being generated by analyzing past performance of said first influencer group.

6. The method of claim 2 further comprising:
displaying at least one aggregated performance statistic for said first influencer group.

7. The method of claim 6, said at least one aggregated performance statistic being generated by:
for each of said plurality of influencers, receiving a past performance statistic;
aggregating said past performance statistic from each of said plurality of influencers to generate said aggregated performance statistic.

8. A system comprising:
at least one processor, said at least one processor configured to perform a method comprising:
receiving a desired demographic profile for an advertising campaign;
identifying a plurality of influencer groups, each of said influencer groups comprising a plurality of influencers;
for each of said plurality of influencer groups, determining a demographic coverage profile;
displaying a plurality of graphical representations, each of said plurality of graphic representations corresponding to one of said influencer groups; and
receiving a selection of a first influencer group.

9. The system of claim 8, said method further comprising:
displaying at least one demographic statistic for said first influencer group.

10. The system of claim 9, said method further comprising:
said demographic statistic being an aggregated demographic statistic, said aggregated demographic statistic being generated by: for each of said plurality of influencers, receiving a demographic profile, and aggregating said demographic profile from each of said plurality of influencers to generate said aggregated demographic statistic.

11. A user interface displayed by a device, said device comprising at least one processor, said user interface comprising:
an identifier for a social media campaign, said social media campaign comprising an advertiser and at least one social media influencer;
at least one representation of a contractual goal between said social media influencer and said advertiser, said contractual goal being part of said social media campaign; and
a set of performance metrics of a plurality of social media influencers, said set of performance metrics containing a first performance metric for each of said plurality of social media influencers.

12. The user interface of claim 11, said plurality of social media influencers being part of said social media campaign.

13. The user interface of claim 11, at least one of said plurality of social media influencers not being part of said social media campaign.

14. The user interface of claim 11, said first performance metric being one of a group composed of:
cost per impression;
click through rate;
conversion rate; and
sales per advertising cost.

15. The user interface of claim 11, said representation of a contractual goal comprising a performance target and a current performance measurement.

16. The user interface of claim 15, said representation of a contractual goal being at least one of a group composed of:
a thermometer;
a gauge;
a graph; and
a number.

17. The user interface of claim 15, said representation of a contractual goal displaying a time dimension.

18. A user interface displayed by a device, said device comprising at least one processor, said user interface comprising:
an identifier for a social media campaign, said social media campaign comprising an advertiser and at least one social media influencer;
at least one representation of a contractual goal between said social media influencer and said advertiser, said contractual goal being part of said social media campaign; and
at least one status representing current performance of said social media influencer with respect to said contractual goal.
